(19) United States
(12) Patent Application Publication
(10) Pub. No.: US 2024/0357432 A1
(43) Pub. Date: Oct. 24, 2024

(54) INFORMATION PROCESSING DEVICE AND STORAGE MEDIUM

(71) Applicant: TOYOTA JIDOSHA KABUSHIKI KAISHA, Toyota-shi (JP)

(72) Inventors: Tomoaki MIYAZAWA, Nagoya-shi (JP); Ryota NAKABAYASHI, Nagoya-shi (JP); Naoki YOMODA, Toyota-shi (JP); Atsushi MORI, Miyoshi-shi (JP); Hiroshi INOUE, Nagoya-shi (JP); Tsukasa KITAZAWA, Toyota-shi (JP)

(73) Assignee: TOYOTA JIDOSHA KABUSHIKI KAISHA, Toyota-shi (JP)

(21) Appl. No.: 18/416,974

(22) Filed: Jan. 19, 2024

(30) Foreign Application Priority Data
Apr. 20, 2023 (JP) 2023-069264

(51) Int. Cl. H04W 28/22

(52) U.S. Cl. CPC H04W 28/22

(57) ABSTRACT

The OTA master downloads data from the OTA server via the off-vehicle network. The processing circuit of the OTA master determines whether the communication speed when downloading data via the external network is less than the determined communication speed. When the processing circuit determines that the communication speed will be less than the determined communication speed, the processing circuit proposes to the user to change the communication plan to a communication plan that allows the communication speed to be higher than or equal to the determined communication speed.

### CROSS-REFERENCE TO RELATED APPLICATION

This application claims priority to Japanese Patent Application No. 2023-069264 filed on Apr. 20, 2023, incorporated herein by reference in its entirety.

### BACKGROUND

### 1. Technical Field

The present disclosure relates to an information processing device that manages download of data via a wireless communication line, and a storage medium to be executed by the information processing device.

### 2. Description of Related Art

Japanese Unexamined Patent Application Publication No. 2022-88980 (JP 2022-88980 A) discloses a communication control device that controls communication between an application executed in a vehicle and an external device outside the vehicle. When data communication is performed between the application and the external device, the communication control device selects a communication line that satisfies communication conditions specified by the application from among a plurality of communication lines.

### SUMMARY

If there are communication restrictions when updating data, it may not be possible to update the data, or it may take a long time to download the data. The user may feel uncomfortable if the data cannot be updated or if it takes a long time to download the data.

An information processing device for addressing the above issue is a device that manages download of data via a wireless communication line.

The information processing device includes a processing circuit.

The processing circuit is configured to:
determine whether a communication speed at a time when the data is downloaded via the wireless communication line becomes less than a determination communication speed; and
propose to a user to change a communication plan to a communication plan that allows the communication speed to be equal to or higher than the determination communication speed when it is determined that the communication speed becomes less than the determination communication speed.

An information processing program for addressing the above issue is a storage medium storing a program to be executed by an information processing device that manages download of data via a wireless communication line.

The information processing program causes the information processing device to perform processes including:
determining whether a communication speed at a time when the data is downloaded via the wireless communication line becomes less than a determination communication speed; and
proposing to a user to change a communication plan to a communication plan that allows the communication speed to be equal to or higher than the determination communication speed when it is determined that the communication speed becomes less than the determination communication speed.

The above information processing device and storage medium have the effect of improving user convenience when downloading data.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a vehicle in which an OTA master, which is an information processing device according to a first embodiment, is installed, a mobile terminal owned by a user of the vehicle, and an OTA server installed outside the vehicle;

FIG. 2 is a table showing an example of a list of communication plans that users of the vehicle shown in FIG. 1 can subscribe to;

FIG. 3 is a flowchart showing a series of processes executed by the OTA master shown in FIG. 1;

FIG. 4 is a sequence diagram showing an example of a process flow when a vehicle downloads data from the OTA server shown in FIG. 1; and

FIG. 5 is a flowchart showing part of a series of processes executed by the OTA master, which is the information processing device of the second embodiment.

### DETAILED DESCRIPTION OF EMBODIMENTS

### First Embodiment

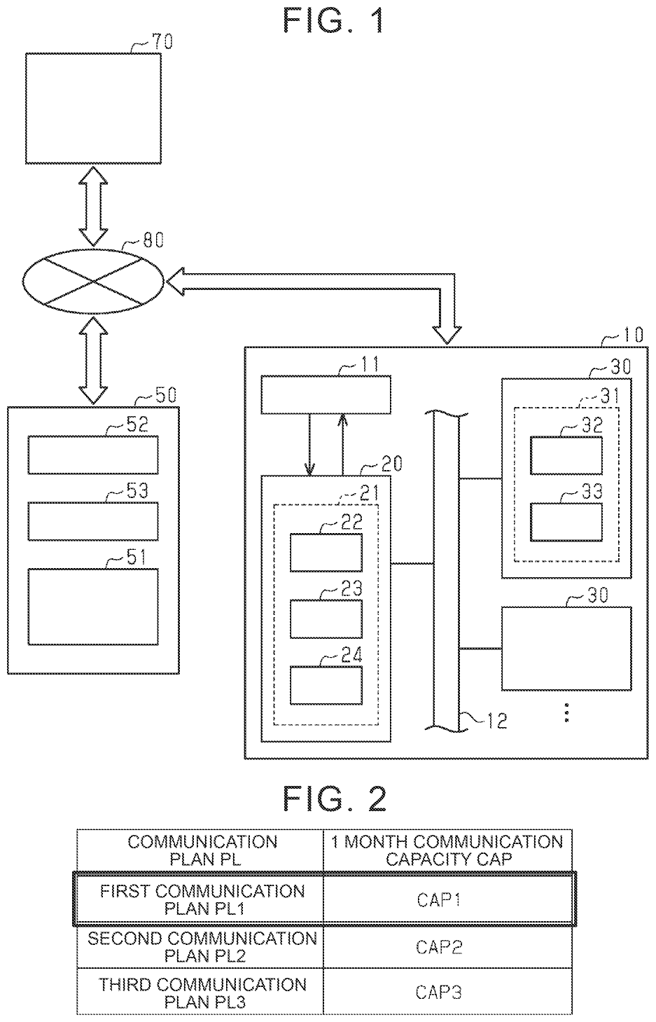

Hereinafter, a first embodiment of an information processing device and an information processing program will be described according to FIGS. 1 to 4.

FIG. 1 illustrates an OTA server 70, a vehicle 10, and a mobile terminal 50 owned by a user of the vehicle 10.

### OTA Server

The OTA server 70 is a data center installed outside the vehicle 10. The OTA server 70 manages software for a plurality of vehicles registered in advance. The OTA server 70 transmits and receives various information to and from the vehicle 10 via the external network 80. The external network 80 is a wireless communication line. For example, the OTA server 70 transmits update software for the vehicle 10 as data to the vehicle 10 in response to a request from the vehicle 10.

### Vehicle

The vehicle 10 includes a communication device 11 and a plurality of electronic control devices. Hereinafter, the electronic control device will be referred to as “ECU”. “ECU” is an abbreviation for “Electronic Control Unit.” The multiple ECUs include an OTA master 20 and multiple target ECUs 30. The OTA master 20 corresponds to an “information processing device” that manages downloading of data via the external network 80.

The communication device 11 is an interface of the vehicle 10 when transmitting and receiving information with a communication device outside the vehicle. For example, the communication device 11 receives update software and information specifying the ECU to be updated from the OTA server 70 via the external network 80. The update target ECU is a target ECU whose software is updated among the plurality of target ECUs 30. For example, the communication device 11 transmits various types of information to the mobile terminal 50 via the external network 80.

The communication device 11 transmits data received from a communication device outside the vehicle to the OTA master 20. The communication device 11 transmits the information received from the OTA master 20 to a communication device outside the vehicle.

The OTA master 20 manages software updates of the target ECU 30. The OTA master 20 can communicate with a plurality of target ECUs 30 via the in-vehicle network 12. An example of the in-vehicle network 12 is CAN. “CAN” is an abbreviation for “Controller Area Network.”

The OTA master 20 includes a processing circuit 21. For example, the processing circuit 21 includes a CPU 22, a first storage device 23, and a second storage device 24. In this case, the first storage device 23 is a nonvolatile memory, and the second storage device 24 is a volatile memory. The first storage device 23 stores software executed by the CPU 22. The second storage device 24 stores various information received from the communication device 11, such as information specifying update software and update mode ECU. That is, the OTA master 20 temporarily stores the data downloaded from the OTA server 70 via the communication device 11 in the second storage device 24.

As the CPU 22 executes the software in the first storage device 23, the processing circuit 21 executes a series of processes for managing the software update of the target ECU 30. The series of processes will be described later.

Each of the plurality of target ECUs 30 includes a processing circuit 31. For example, the processing circuit 31 includes a CPU 32 and a storage device 33. The storage device 33 is a nonvolatile memory. The storage device 33 stores various types of software executed by the CPU 32. When the processing circuit 31 of the target ECU 30 receives the update software from the OTA master 20 via the in-vehicle network 12, it writes the update software into the storage device 33. Thereafter, the processing circuit 31 completes the software update of the storage device 33 by executing an activation process.

### Mobile Device

The mobile terminal 50 includes a user interface 51, a communication device 52, and a processing circuit 53. The user interface 51 includes a display section that displays information to be notified to the user, and an operation section that is operated by the user.

Communication device 52 is an interface of mobile terminal 50 for communicating with vehicle 10 via the external network 80. The communication device 52 receives information transmitted by the vehicle 10 via the external network 80.

An example of the processing circuit 53 is an electronic control device. In this case, the processing circuit 53 includes a CPU and a storage device. The storage device stores a control program executed by the CPU. The processing circuit 53 executes various processes as the CPU executes the control program. For example, the processing circuit 53 causes the display section of the user interface 51 to display a message according to the information received by the communication device 52. For example, the processing circuit 53 causes the communication device 52 to transmit information corresponding to the result of the user's operation of the operation unit of the user interface 51 to the vehicle 10.

### Communication Plan

With reference to FIG. 2, a communication plan for data communication between a communication device outside the vehicle and the vehicle 10 will be described.

As shown in FIG. 2, a plurality of communication plans PL is prepared as communication plans that users can subscribe to. In the example shown in FIG. 2, the plurality of communication plans PL includes three communication plans PL1, PL2, and PL3 with different communication capacities CAP that can be used in one month. The first 20 communication capacity CAP1 of the first communication plan PL1 is smaller than either of the second communication capacity CAP2 of the second communication plan PL2 and the third communication capacity CAP3 of the third communication plan PL3. The third communication capacity CAP3 is larger than either the first communication capacity CAP1 or the second communication capacity CAP2. The communication plan PL with a larger communication capacity CAP has a higher monthly fee. In this embodiment, it is assumed that the user of the vehicle 10 has subscribed to the first communication plan PL1.

When the communication capacity used by the vehicle 10 within one month is defined as the used capacity UCAP, if the used capacity UCAP is less than or equal to the communication capacity CAP of the communication plan PL, data communication is not possible between the communication device outside the vehicle and the vehicle 10. There are no communication restrictions when this is done. If there are no communication restrictions, the communication speed during data communication will not decrease. On the other hand, if the usage capacity UCAP exceeds the communication capacity CAP of the communication plan PL, communication restrictions are imposed when data communication is performed between the communication device outside the vehicle and the vehicle 10. When communication restrictions are applied, the communication speed when performing data communication becomes extremely low compared to when communication restrictions are not applied.

### Download Data

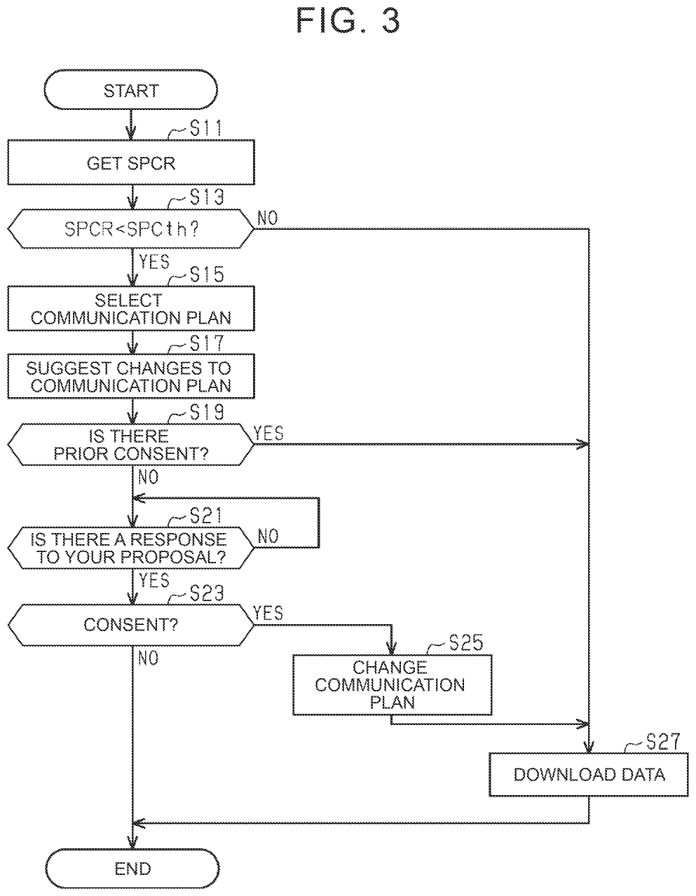

With reference to FIG. 3, a series of processes executed by the processing circuit 21 of the OTA master 20 when the OTA master 20 downloads data from the OTA server 70 will be described. When the CPU 22 executes the information processing program in the first storage device 23, the processing circuit 21 executes the series of processes. Note that, prior to downloading data from the OTA server 70, the processing circuit 21 starts executing a series of processes.

In S11, the processing circuit 21 obtains an actual measurement value SPCR of the communication speed by actually measuring the communication speed when performing data communication between the OTA server 70 and the vehicle 10.

In the next S13, the processing circuit 21 determines whether the actual measurement value SPCR of the communication speed is less than the determined communication speed SPCth. A criterion for determining whether the communication speed when performing data communication between the OTA server 70 and the vehicle 10 when downloading data from the OTA server 70 is too slow is set as the determined communication speed SPCth. For example, when communication is restricted as described above, the communication speed becomes less than the determined communication speed SPCth. On the other hand, the determined communication speed SPCth is set to a communication speed such that the communication speed does not become less than the determined communication speed SPCth when no communication restriction is applied. Then, if the actual measurement value SPCR of the communication speed is less than the determined communication speed SPCth, the processing circuit 21 determines that the communication speed when downloading data via the external network 80 is less than the determined communication speed SPCth. In other words, the process of S13 corresponds to the process of determining whether the communication speed when data is downloaded via the external network 80 is less than the determined communication speed SPCth.

When the actual measurement value SPCR of the communication speed is less than the determined communication speed SPCth (S13: YES), the processing circuit 21 shifts the process to S15. On the other hand, if the actual measurement value SPCR of the communication speed is equal to or higher than the determined communication speed SPCth (S13: NO), the processing circuit 21 shifts the process to S27.

In S15, the processing circuit 21 selects a communication plan PL that allows the communication speed to be equal to or higher than the determined communication speed SPCth from among the plurality of communication plans PL1 to PL3 shown in FIG. 2. For example, if there are multiple communication plans PL that allow the communication speed to be higher than the determined communication speed SPCth, the processing circuit 21 selects the communication plan PL with the lowest charge from among the multiple communication plans PL.

In subsequent S17, the processing circuit 21 proposes the communication plan PL selected in S15 to the user. That is, the process of S17 corresponds to the process of proposing to the user to change the communication plan to a communication plan that allows the communication speed to be higher than the determined communication speed SPCth. For example, the processing circuit 21 causes the communication device 11 to transmit information regarding the selected communication plan PL to the user's mobile terminal 50.

In the mobile terminal 50, when the communication device 52 receives the above information, the processing circuit 53 causes the display unit of the user interface 51 to display a message proposing a change to the communication plan PL indicated by the information. When the user who has viewed the message operates the operation section of the user interface 51, the processing circuit 53 transmits information corresponding to the operation to the vehicle 10 as a response to the proposal.

After the processing circuit 21 of the OTA master 20 executes the process for proposing a change to the communication plan PL, the process proceeds to S19. In S19, the processing circuit 21 determines whether the user has consented in advance to changing the communication plan PL in the event of communication restrictions. If the user has approved the change in communication plan PL in advance (S19: YES), the processing circuit 21 moves the process to S27. On the other hand, if the user has not approved the change in the communication plan PL in advance (S19: NO), the processing circuit 21 shifts the process to S21.

In S21, the processing circuit 21 determines whether information regarding a response to the proposal to change the communication plan PL has been received from the mobile terminal 50. If the processing circuit 21 has received the information regarding the answer (S21: YES), the process proceeds to S23. On the other hand, if the processing circuit 21 has not received information regarding the answer (S21: NO), the processing circuit 21 repeats the determination in S21.

In S23, the processing circuit 21 determines whether the user has approved the change in the communication plan PL based on the information received from the mobile terminal 50. When the processing circuit 21 determines that the user has approved the change in the communication plan PL (S23: YES), the process proceeds to S25. On the other hand, if the processing circuit 21 determines that the user has not approved the change in the communication plan PL (S23: NO), the processing circuit 21 ends the series of processes. In this case, the processing circuit 21 does not download data from the OTA server 70.

In S25, the processing circuit 21 changes the communication plan PL subscribed to by the user to the communication plan PL selected in S15. Then, the processing circuit 21 moves the process to S27.

In S27, the processing circuit 21 downloads data from the OTA server 70.

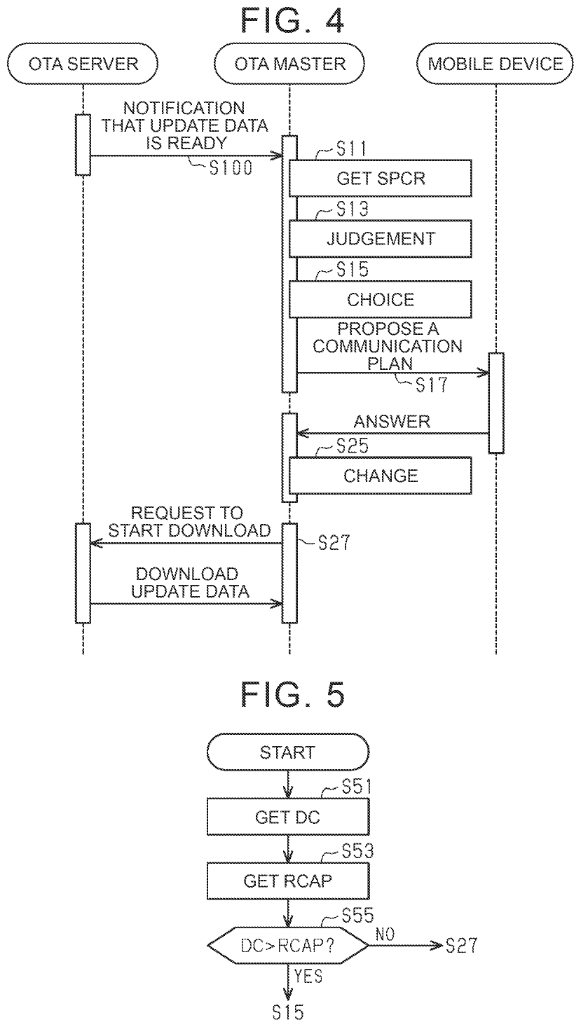

When the data download is completed, the processing circuit 21 ends the series of processing. Effects of this embodiment With reference to FIG. 4, the operation when the vehicle 10 downloads data from the OTA server 70 will be described.

The OTA server 70 notifies the OTA master 20 of the vehicle 10 that the update data is ready (S100).

Then, in the OTA master 20, the processing circuit 21 obtains the actual measurement value SPCR of the communication speed (S11). Then, the processing circuit 21 determines whether the actual measured value SPCR is less than the determined communication speed SPCth (S13). If the actual measurement value SPCR is less than the determined communication speed SPCth, communication restrictions will be applied when downloading update data from the OTA server 70. Therefore, if the actual measurement value SPCR is less than the determined communication speed SPCth (S13: YES), the processing circuit 21 selects a communication plan that will prevent the communication speed from becoming less than the determined communication speed SPCth while downloading the update data (S15). Then, the processing circuit 21 proposes changing the communication plan PL with which the user subscribes to the communication plan PL selected in S15 (S17). At this time, the processing circuit 21 causes the communication device 11 to transmit information regarding the proposal to the mobile terminal 50.

Then, in the mobile terminal 50, the processing circuit 53 displays a message indicating the above proposal on the display section of the user interface 51. Then, the user decides whether to accept the proposal by operating the operation section of the user interface 51. Then, information regarding the answer to the above proposal is transmitted from the mobile terminal 50 to the vehicle 10.

In the OTA master 20, the processing circuit 21 receives information regarding the above response (S21: YES). If the above answer is an answer to the effect that changing the communication plan PL is permitted, the processing circuit 21 changes the communication plan PL (S25). Thereby, the communication speed when downloading the update data does not become less than the determined communication speed SPCth. Therefore, the processing circuit 21 starts downloading the update data (S27). That is, the processing circuit 21 requests the OTA server 70 to start downloading.

Upon receiving the request to start downloading, the OTA server 70 transmits update data to the vehicle 10. Thereby, in the OTA master 20, the processing circuit 21 can download the update data.

### Effects of this Embodiment

(1-1) If the OTA master 20 determines that the communication speed when downloading data via the external network 80 is less than the determined communication speed SPCth, the OTA master 20 suggests to the user that the communication plan PL is changed to the communication plan that allows the communication speed to be changed to the determined communication speed SPCth or higher. If the user accepts such a proposal, the communication plan PL is changed. As a result, the communication speed when downloading data is suppressed from becoming less than the determined communication speed SPCth. This prevents downloading data from taking too much time.

On the other hand, if the user does not accept the above proposal, the OTA master 20 will not download the data because the communication plan PL will not be changed. In this case, the user knows that the data will not be downloaded due to his/her decision not to change the communication plan PL.

Therefore, the OTA master 20 can improve user convenience when downloading data.

Note that when the OTA master 20 determines that the communication speed is equal to or higher than the determined communication speed SPCth, the OTA master 20 downloads the data without changing the communication plan PL.

(1-2) Prior to downloading data, the OTA master 20 obtains the actual measurement value SPCR of the communication speed. Then, when the actual measured value SPCR is less than the determined communication speed SPCth, the OTA master 20 determines that the communication speed becomes less than the determined communication speed SPCth during data download. In other words, the OTA master 20 can determine whether the communication speed will be less than the determined communication speed SPCth, even if the OTA master 20 does not know the communication plan PL that the user has subscribed to.

### Second Embodiment

A second embodiment of the information processing device and the information processing program will be described with reference to FIG. 5. The second embodiment differs from the first embodiment in the method of determining whether the communication speed is less than the determined communication speed. Therefore, in the following description, parts that are different from the first embodiment will be mainly explained, and the same reference numerals will be given to the same member configurations as in the first embodiment, and redundant explanation will be omitted.

With reference to FIG. 5, a series of processes executed by the processing circuit 21 of the OTA master 20 when the OTA master 20 downloads data from the OTA server 70 will be described.

In S51, the processing circuit 21 obtains the capacity DC of data to be downloaded from the OTA server 70. In subsequent S53, the processing circuit 21 obtains the specified communication capacity RCAP, which is the communication capacity that can be used this month. For example, the processing circuit 21 obtains the value obtained by subtracting the usage capacity UCAP from the communication capacity CAP of the communication plan PL with which the user has subscribed, as the specified communication capacity RCAP.

In the next S55, the processing circuit 21 determines whether the data capacity DC acquired in S51 is larger than the specified communication capacity RCAP. If the data capacity DC is larger than the specified communication capacity RCAP, communication restrictions are applied while the data is being downloaded, resulting in a significant reduction in communication speed. On the other hand, if the data capacity DC is less than the specified communication capacity RCAP, no communication restriction is applied while the data is being downloaded, so the communication speed does not decrease. Therefore, if the data capacity DC is larger than the specified communication capacity RCAP, the processing circuit 21 determines that the communication speed becomes less than the determined communication speed SPCth during data download. On the other hand, if the data capacity DC is less than or equal to the specified communication capacity RCAP, the processing circuit 21 determines that the communication speed will not become less than the determined communication speed SPCth during data download. That is, the process of S55 corresponds to the process of determining whether the communication speed when downloading data via the external network 80 is less than the determined communication speed SPCth.

When the data capacity DC is larger than the specified communication capacity RCAP (S55: YES), the processing circuit 21 shifts the process to S15 shown in FIG. 3. On the other hand, if the data capacity DC is equal to or less than the specified communication capacity RCAP (S55: NO), the processing circuit 21 shifts the process to S27 shown in FIG. 3. Note that the flow of processing after S15 is the same as in the first embodiment, and therefore will not be described.

### Actions and Effects of this Embodiment

In this embodiment, in addition to the same effect as the effect (1-1) of the first embodiment, the following effects can be further obtained.

(2-1) If the capacity DC of the data scheduled to be downloaded is larger than the specified communication capacity RCAP, the OTA master 20 determines that the communication speed when downloading the data will be less than the determined communication speed SPCth. Therefore, the OTA master 20 can propose a communication plan PL to the user when there is a possibility that the communication speed when downloading data will be less than the determined communication speed SPCth.

On the other hand, if the capacity DC of the data scheduled to be downloaded is less than or equal to the specified communication capacity RCAP, the OTA master 20 determines that the communication speed when downloading the data will not become less than the determined communication speed SPCth. Therefore, the OTA master 20 downloads data from the OTA server 70.

Therefore, the OTA master 20 can suppress the occurrence of an event in which communication is restricted and the communication speed suddenly slows down while data is being downloaded.

### Modifications

The above embodiments can be modified and implemented as follows. The plurality of embodiments described above and the following modified examples can be implemented in combination with each other within a technically consistent range.

Even if the actual measured value SPCR of the communication speed is equal to or higher than the determined communication speed SPCth before the start of data download, the actual measured value SPCR of the communication speed may become less than the determined communication speed SPCth during the download. Therefore, if the user has consented in advance to change the communication plan, the processing circuit 21 of the OTA master 20 detects that the actual communication speed value SPCR becomes less than the determined communication speed SPCth during the download. Change your communication plan when the situation arises. This may allow data to continue to be downloaded.

Assume that the communication plan is a plan in which one of a plurality of communication lines with different communication speeds is selected. In this case, when the processing circuit 21 of the OTA master 20 determines that the communication speed is less than the determined communication speed SPCth, the processing circuit 21 of the OTA master 20 may suggest to the user to change to the communication plan in which a communication plan that is different from the currently selected communication line is selected.

In the above embodiments, the OTA master 20 mounted on the vehicle 10 functions as an information processing device, but the present disclosure is not limited to this. For example, the OTA server 70 may function as an information processing device. In this case, the OTA server 70 transmits data to the vehicle 10 when determining that the communication speed does not become less than the determined communication speed SPCth. On the other hand, if the OTA server 70 determines that the communication speed will be less than the determined communication speed SPCth, it proposes a change in the communication plan PL to the user of the vehicle 10.

In the above embodiments, the ECU installed in the vehicle 10 corresponds to an information processing device. However, a control device for a communication device other than an in-vehicle ECU may be used as an information processing device.

The processing circuit included in the information processing device is not limited to one that includes a CPU and a ROM and executes software processing. That is, the processing circuit may have any of the following configurations (a), (b), and (c).
(a) The processing circuit includes one or more processors that execute various processes according to a computer program. The processor includes a CPU and memory such as RAM and ROM. The memory stores a program code or an instruction configured to execute the CPU to perform processes. Memory, or computer-readable media, includes any available media that can be accessed by a general purpose or special purpose computer.
(b) The processing circuit includes one or more dedicated hardware circuits that perform various processes. Dedicated hardware circuits may include, for example, application specific integrated circuits, i.e. ASICs or FPGAs. Note that ASIC is an abbreviation for “Application Specific Integrated Circuit,” and FPGA is an abbreviation for “Field Programmable Gate Array.”
(c) The processing circuit includes a processor that executes some of the various processes according to a computer program, and a dedicated hardware circuit that executes the remaining processes of the various processes.

What is claimed is:

1. An information processing device that manages download of data via a wireless communication line, comprising a processing circuit, wherein the processing circuit is configured to:
determine whether a communication speed at a time when the data is downloaded via the wireless communication line becomes less than a determination communication speed; and
propose to a user to change a communication plan to a communication plan that allows the communication speed to be equal to or higher than the determination communication speed when it is determined that the communication speed becomes less than the determination communication speed.

2. The information processing device according to claim 1, wherein the processing circuit determines that the communication speed becomes less than the determination communication speed when an actual measurement value of the communication speed is less than the determination communication speed.

3. The information processing device according to claim 1, wherein
when a communication capacity that is available to the user is defined as a specified communication capacity,
the processing circuit determines that the communication speed becomes less than the determination communication speed when a volume of the data to be downloaded is larger than the specified communication capacity.

4. The information processing device according to claim 1, wherein:
the information processing device is an electronic control device mounted on a vehicle; and
the processing circuit is configured to
determine whether the communication speed becomes less than the determination communication speed before the download of the data is started, and
download the data from a data center installed outside a vehicle when it is determined that the communication speed does not become less than the determination communication speed.

5. A non-transitory storage medium storing an information processing program to be executed by an information processing device that manages download of data via a wireless communication line, the information processing program causing the information processing device to perform processes comprising:
determining whether a communication speed at a time when the data is downloaded via the wireless communication line becomes less than a determination communication speed; and
proposing to a user to change a communication plan to a communication plan that allows the communication speed to be equal to or higher than the determination communication speed when it is determined that the communication speed becomes less than the determination communication speed.
